(19) United States
(12) Patent Application Publication
(10) Pub. No.: US 2014/0301762 A1
(43) Pub. Date: Oct. 9, 2014

(54) IMAGE FORMING APPARATUS

(71) Applicant: CANON KABUSHIKI KAISHA, Tokyo (JP)

(72) Inventors: Koji Inoue, Tokyo (JP); Taku Higashiyama, Yokohama-shi (JP)

(73) Assignee: CANON KABUSHIKI KAISHA, Tokyo (JP)

(21) Appl. No.: 14/244,185

(22) Filed: Apr. 3, 2014

(30) Foreign Application Priority Data
Apr. 9, 2013 (JP) 2013-081031

(51) Int. Cl. G03G 15/20

(52) U.S. Cl. CPC G03G 15/2053
USPC 399/333

(57) ABSTRACT

A heating member has a multi-layered structure of n layers in total to which layer numbers are assigned sequentially from one on a heat source side to a surface in contact with a recording medium. A n^{-th} layer is heated by the heat source. Thermal permeability of the n^{-th} layer is larger than thermal permeability of a n−1^{-th} layer and satisfies a following relationship:

\sqrt{αₙt}≦dₙ
where, αₙ[m²/s] is thermal diffusivity of the n^{-th} layer, and
dₙ[m] is a thickness of the n^{-th} layer.

### BACKGROUND OF THE INVENTION

1. Field of the Invention

The present invention relates to an image heating apparatus configured to heat a recording medium at a nip portion between a heating member having an elastic layer and a conveying member, and more specifically to a layer structure of the heating member permitting to lower a target temperature in temperature control of an outer surface temperature of the heating member without hampering performance thereof in heating the recording medium.

2. Description of the Related Art

An image forming apparatus configured to transfer a toner image carried on an image carrier to a recording medium and to fix an image on the recording medium by heating and pressing the recording medium on which the toner image has been transferred at a nip portion of a fixing apparatus, i.e., one exemplary image heating apparatus, is being widely used. The image heating apparatus has the nip portion for the recording medium formed by making a conveying member (a roller member or a belt member) into contact with the heating member (a roller member or a belt member). The heating member is provided with an elastic layer having rubbery elasticity on a base layer (a cylindrical member or a belt member) bearing strength of the heating member to enhance followability thereof to unevenness of a surface of the recording medium.

Japanese Patent Application Laid-open No. 2007-219371 enhances thermal conductivity of a fixing belt in a thickness direction thereof by blending oxide metallic thermal conductive fillers such as alumina and silica into a silicone rubber material forming an elastic layer. Japanese Patent Application Laid-open No. 2005-302691 provides a fluorine resin release layer having high releasability to melted toner on an elastic layer and enhances thermal conductivity of the release layer by blending metallic thermal conductive fillers such as gold and nickel into the fluorine resin material of the release layer.

If quality of a heat-processed image and heat processing speed are same in the image heating apparatus, it is desirable to be able to lower an outer surface temperature of the heating member. The lower the outer surface temperature of the heating member, the less the heat radiated from the whole surface is, so that power required to keep the outer surface temperature of the heating member can be saved. The lower the outer surface temperature of the heating member, the less the wear rate of the release layer on the surface of the heating member is, so that a replacement life of the heating member can be also prolonged.

It was confirmed that it is possible to lower the outer surface temperature of the heating member by lowering a target temperature in temperature control in a case where the thermal conductivity of the release layer is increased as disclosed in Japanese Patent Application Laid-open No. 2005-302691. However, its effect cannot be said to be enough by a thickness of the release layer disclosed in Japanese Patent Application Laid-open No. 2005-302691, and it is necessary to increase the target temperature by a certain degree in the temperature control in order to assure the quality of an heat-processed image and the heat processing speed. Accordingly, it is unable to fully lower the outer surface temperature of the heating member.

### SUMMARY OF THE INVENTION

According to a first aspect of the present invention, an image heating apparatus includes a heat source, a heating member heated by the heat source, a conveying member forming a nip portion conveying a recording medium by being in contact with the heating member, the heating member including a base layer heated by the heat source, an elastic layer disposed on the base layer, and a release layer disposed on the elastic layer, and the heating member holding a relationship of the following equation: equation:

\sqrt{α₃t}≦d₃

where,

λ₂[W/(m·K)] is thermal conductivity of the elastic layer,

C₂[J/(m³·K)] is heat capacity of the elastic layer,

b₂[J/(m²·K·s^{0.5})](=\sqrt{λ₂C₂}) is thermal permeability of the elastic layer,

d₂[m] is a thickness of the elastic layer,

λ₃[W/(m·K)] is thermal conductivity of the release layer,

C₃[J/(m³·K)] is heat capacity of the release layer,

b₃[J/(m²·K·s^{0.5})](=\sqrt{λ₃C₃}) is thermal permeability of the elastic layer,

d₃[m] is a thickness of the release layer,

the thermal permeability b₃ of the release layer being greater than the thermal permeability b₂ of the elastic layer,

α₃[m²/s] is thermal diffusivity of the release layer, and

t [s] is the recording medium stay time at the nip portion.

According to a second aspect of the present invention, an image heating apparatus includes a heat source, a heating member heated by the heat source, a conveying member forming a nip portion conveying a recording medium by being in contact with the heating member, the heating member having a multi-layered structure of n layers in total assigned by layer numbers sequentially from one on the heat source side to the surface in contact with the recording medium, and the heating member holding a relationship of the following equation:

\sqrt{αₙt}≦dₙ

where,

λⱼ[W/(m·K)] is thermal conductivity of a j^{-th} (j=1 to n) layer,

Cⱼ[J/(m³·K)] is heat capacity of the j^{-th} (j=1 to n) layer,

bⱼ[J/(m²·K·s^{0.5})](=\sqrt{λⱼCⱼ}) is thermal permeability of the j^{-th} (j=1 to n) layer,

dⱼ[m] is a thickness of the j^{-th} (j=1 to n) layer,

the thermal permeability bₙ of the n^{-th} layer being greater than the thermal permeability bₙ₋₁ of the fixing roller 1-n^{-th} layer,

αₙ[m²/s] is thermal diffusivity of the j^{-th} (j=1 to n) layer,

dₙ[m] is a thickness of the n^{-th} layer, and

t[s] is the recording medium stay time at the nip portion.

Further features of the present invention will become apparent from the following description of exemplary embodiments (with reference to the attached drawings).

### BRIEF DESCRIPTION OF THE DRAWINGS

FIG. 1 is a schematic diagram illustrating a part of a configuration of an image forming apparatus.

FIG. 2 is a diagram illustrating a configuration of a fixing apparatus of a first embodiment.

FIG. 3A is a graph indicating changes of a temperature distribution in a diameter direction at a nip portion.

FIG. 3B is a graph indicating changes of a temperature distribution in a diameter direction of a heating member.

FIG. 4 is a graph indicating results of study implemented on thicknesses of a release layer.

FIG. 5A is a graph indicating a relationship between a lowest fixing temperature and thermal permeability in a case where the thickness of the release layer is 30 μm.

FIG. 5B is a graph indicating a relationship between the lowest fixing temperature and the thermal permeability in a case where the thickness of the release layer is 200 μm.

FIG. 6 is a graph explaining a temperature distribution in a depth direction in the case where the thickness of the release layer is 30 μm.

FIG. 7A is a graph indicating a relationship between the thickness of the release layer and the lowest fixing temperature.

FIG. 7B is a graph indicating a relationship between the thickness of the release layer and the lowest fixing temperature by consolidating a tendency of the lowest fixing temperature by a thermal diffusion length.

FIG. 8 is a diagram explaining a parameter of each layer of a fixing roller.

FIG. 9 is a graph explaining changes of an outer surface temperature in one rotation of the fixing roller.

FIG. 10 is a graph explaining an upper limit value of the thickness of the release layer.

FIG. 11 is a graph explaining a relationship between a supply power and a maximum allowable thickness of the release layer.

FIG. 12 is a diagram illustrating a configuration of a fixing apparatus of a second embodiment.

FIG. 13 is a graph explaining changes of an outer surface temperature in one rotation of a fixing belt.

FIG. 14 is a graph explaining changes of an inner surface temperature in one rotation of the fixing belt.

FIG. 15 is a graph explaining an upper limit value of the thickness of the release layer.

FIG. 16 is a graph explaining a relationship between the supply power and the maximum allowable thickness of the release layer.

FIG. 17 is a diagram illustrating a configuration of a fixing apparatus of a third embodiment.

FIG. 18 is a diagram illustrating a configuration of a fixing apparatus of a fourth embodiment.

FIG. 19 is a diagram illustrating a configuration of a fixing apparatus of a fifth embodiment.

### DESCRIPTION OF THE EMBODIMENTS

Embodiments of the present invention will be explained below with reference to the drawings.

### First Embodiment

### Image Forming Apparatus

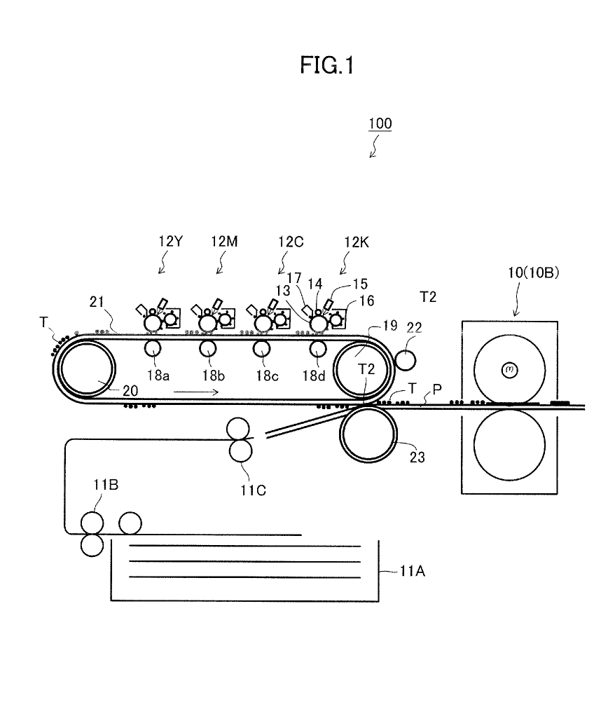

FIG. 1 is a diagram schematically showing a part of a configuration of an image forming apparatus 100. As shown in FIG. 1, the image forming apparatus 100 is a tandem type intermediate transfer type full-color printer in which yellow, magenta, cyan, and black image forming portions 12Y, 12M, 12C, and 12K are arrayed along an intermediate transfer belt 21.

In the image forming portion 12Y, a yellow toner image is formed on a photoconductive drum 13(Y) and is transferred to the intermediate transfer belt 21. In the image forming portion 12M, a magenta toner image is formed on a photoconductive drum 13(M) and is transferred to the intermediate transfer belt 21. In the image forming portions 12C and 12K, cyan and black toner images are formed respectively on photoconductive drums 13(C) and 13(K) and are transferred to the intermediate transfer belt 21.

The four color toner images carried on the intermediate transfer belt 21 are conveyed to a secondary transfer portion T2 and are secondarily transferred altogether on a recording medium P. The recording medium taken out of a recording medium cassette 11A is separated one by one by a separation roller 11B and is conveyed to a registration roller 11C. The registration roller 11C feeds the recording medium P to the secondary transfer portion T2 by adjusting a feed timing with the toner image on the intermediate transfer belt 21.

A secondary transfer roller 23 forms the secondary transfer portion T2 by being into contact with the intermediate transfer belt 21 which is wrapped around a drive roller 19 that functions also as an intra-secondary transfer roller. A fixing apparatus 10 is configured to fix an image on the recording medium P by heating and pressing the recording medium P. The recording medium P which has passed through the secondary transfer portion T2 and on which the toner image has been secondarily transferred separates by itself from the intermediate transfer belt 21 and is sent to the fixing apparatus 10. The recording medium P on which the image has been fixed by the fixing apparatus 10 is then discharged out of the apparatus.

### (Image Forming Portion)

The image forming portions 12Y, 12M, 12C, and 12K are constructed substantially in the same manner except that the colors of the toners used in respective developing units are different as yellow, magenta, cyan, and black. Therefore, only a toner image forming process of black image forming portion 12K will be explained below, and an overlapped explanation of the other image forming portions 12Y, 12M, and 12C will be omitted here.

The image forming portion 12K is provided with a charging roller 14, an exposure unit 15, a developing unit 16, a primary transfer roller 18d, and a drum cleaning unit 17 around the photoconductive drum 13. The photoconductive drum 13 has a photoconductive layer on a surface thereof and rotates at a predetermined processing speed. The charging roller 14 charges the surface of the photoconductive drum 13 with a homogeneous potential. The exposure unit 15 scans a laser beam by a rotary mirror to write an electrostatic image of an image on the surface of the photoconductive drum 13.

The developing unit 16 moves the toner to the photoconductive drum 13 to develop the electrostatic image as a toner image. By being applied with a voltage, the primary transfer roller 18d transfers the toner image carried on the photoconductive drum 13 to the intermediate transfer belt 21. The drum cleaning unit 17 rubs the photoconductive drum 13 by a cleaning blade to recover transfer residual toner left on the photoconductive drum 13.

The intermediate transfer belt 21 is wrapped around and supported by the drive roller 19, a tension roller 20 and primary transfer rollers 18a, 18b, 18c and 18d, and is driven by the drive roller 19 and rotates in a direction of an arrow in FIG. 1. A belt cleaning unit 22 recovers transfer residual toner on the intermediate transfer belt 21 passing through the secondary transfer portion T2. The secondary transfer roller 23 rotates by being driven by the intermediate transfer belt 21.

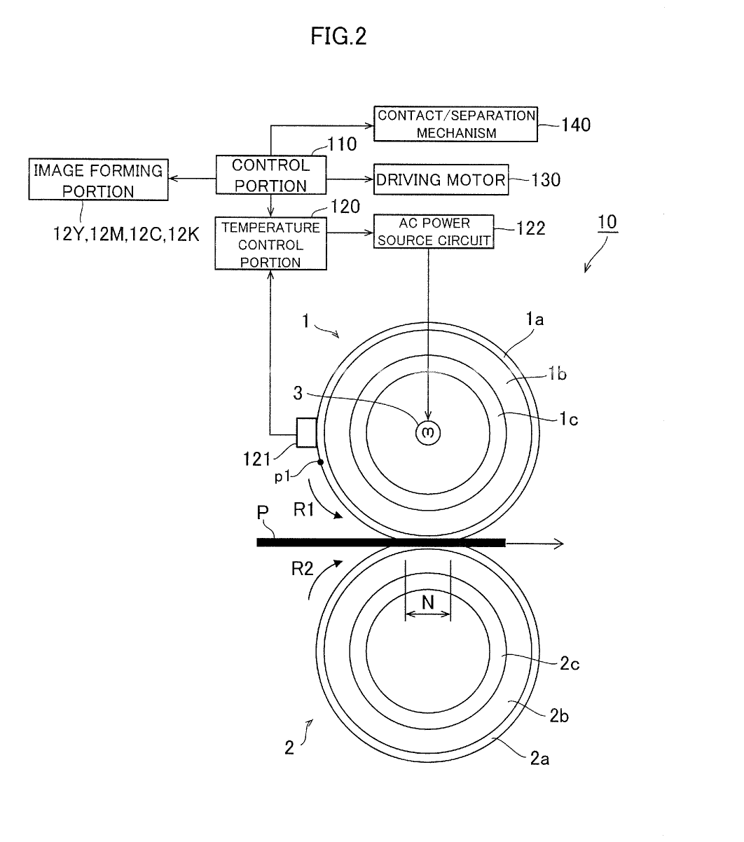

As shown in FIG. 2, a fixing roller 1, i.e., one exemplary heating member, of the fixing apparatus 10 is heated by a halogen lump 3, i.e., one exemplary heat source. A pressure roller 2, i.e., one exemplary conveying member, comes into contact with the fixing roller 1 and forms a nip portion N where the recording medium is conveyed. A base layer 1c is heated by the halogen lump 3. An elastic layer 1b is disposed on the base layer 1c, and a release layer 1a is disposed on the elastic layer 1b. Thermal permeability of the release layer 1a is greater than that of the elastic layer 1b.

A thickness d of the release layer 1a is expressed by the following equation, where α is thermal diffusivity of the release layer 1a and t is a stay time of the recording medium at the nip portion N. This equation will be detailed later.

\sqrt{αt}≦d Eq. 1

In order to prevent toner offset by which toner moves to the fixing roller 1, a layer whose contact angle to melted toner on a surface of the release layer is greater than a contact angle to the melted toner on a surface of the elastic layer 1b in a same temperature is provided as the release layer 1a.

### (Fixing Apparatus)

FIG. 2 is a diagram explaining a configuration of the fixing apparatus 10 of the present embodiment. The fixing apparatus 10 is configured to heat and press the recording medium P on which the toner image has been transferred at the nip portion N where the fixing roller 1 is in contact with the pressure roller 2 to fix the image onto the recording medium P.

The fixing roller 1 is 300 mm in length and 30 mm in diameter. The fixing roller 1 is provided with the elastic layer 1b made of silicone rubber formed on the base layer 1c of a steel pipe of 1 mm thick. The elastic layer 1b gives flexibility on a surface of the fixing roller 1 so that the fixing roller 1 can follow unevenness of a surface of the recording medium. It is possible to adjust a length in a rotational direction of the nip portion N (nip width) and an image quality by adjusting a thickness and hardness of the elastic layer 1b. The surface of the elastic layer 1b is coated by the release layer 1a using a fluorine resin rubber material whose contact angle to the melted toner is greater than that of a silicone rubber. The release layer 1a exhibits releasability to the melted toner.

The pressure roller 2 is also 300 mm in length and 30 mm in diameter. The pressure roller 2 is provided with an elastic layer 2b made of silicone rubber of 200 μm thick formed on a base layer 2c of a steel pipe of 1 mm thick. The elastic layer 2b gives flexibility on a surface of the pressure roller 2 to improve a state of contact of the fixing roller 1 with the surface of the recording medium. The surface of the elastic layer 2b is coated by a release layer 2a of a fluorine resin (PFA) of 50 μm thick. The release layer 2a facilitates separation of the recording medium P.

By being driven by a driving motor 130, the fixing roller 1 rotates in a direction of an arrow R1. The pressure roller 2 can be brought into contact with and separated from the fixing roller 1 by a contact/separation mechanism 140. The pressure roller 2 is pressed toward the fixing roller 1 by the contact/separation mechanism 140 and forms a nip portion by being in contact with the fixing roller 1.

The pressure roller 2 rotates in a direction of an arrow R2 by being driven by the driving motor 130 during when the pressure roller 2 is separated from the fixing roller 1. When the pressure roller 2 is in pressure contact with the fixing roller 1, the pressure roller 2 is separated from the drive of the driving motor 130 by a one-way clutch not shown and rotates by being driven by the rotation of the fixing roller 1.

The halogen lump 3 is disposed on a center axis of the fixing roller 1 and heats the base layer 1c of the fixing roller 1 from inside thereof. A length of a light emitting portion of the halogen lump 3 is 324 mm. A temperature control portion 120 controls an AC power circuit not shown to feed power to the halogen lump 3 such that the halogen lump 3 generates radiant heat. The radiant heat of the halogen lump 3 heats the base layer 1c of the fixing roller 1 and rises temperature of the fixing roller 1.

A temperature sensor 121 detects an outer surface temperature of the fixing roller 1 at a position just before the nip portion N. Electrical information concerning the temperature outputted from the temperature sensor 121 is inputted to the temperature control portion 120. The temperature control portion 120 controls the output of the AC power circuit and regulates a power supplied to the halogen lump 3 such that the temperature detected by the temperature sensor 121 keeps a target temperature (fixing temperature) in temperature control. Thus, the temperature of the surface of the fixing roller 1 rises to the fixing temperature set in advance and is kept at the fixing temperature.

### (Explanation of Parameters of Heating Roller)

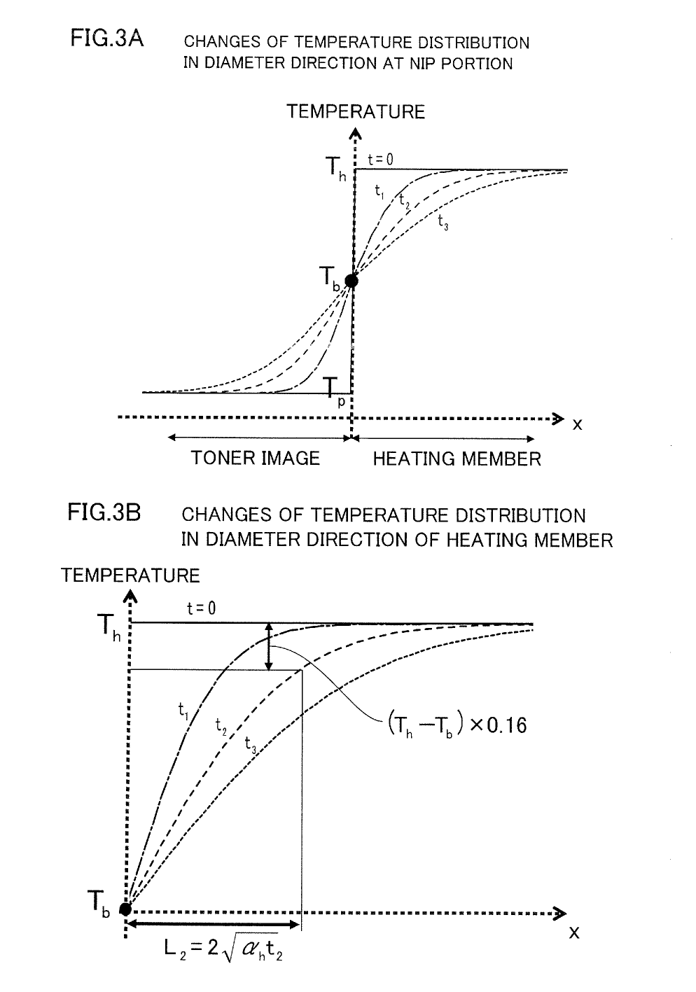

FIGS. 3A and 3B are graphs explaining changes of a temperature distribution in a diameter direction at the nip portion. Here, a heat transfer phenomenon at the nip portion between the heating member and the conveying member will be described and various parameters to be used will be explained by using relational expressions of heat transfer engineering shown in “Heat Transfer Engineering” written by Toshio Aihara, Shokabo Publishing Co., Ltd., pp. 31 through 35.

Here, changes of the temperature distribution in the diameter direction of the fixing roller 1 of a point p1 in a process in which the point p1 on the fixing roller 1 enters and passes through the nip portion N as shown in FIG. 2 will be studied. While the point p1 on the fixing roller 1 drops its temperature by passing through the nip portion N, the point p1 receives heat supplied from the halogen lump 3 while it turns substantially one round and restores its temperature to the target temperature in the temperature control. The point p1 enters the nip portion N again, and its heat is taken away by the recording medium P.

As shown in FIG. 3A, the temperature of the point p1 drops to Tb at a moment when the point p1 on the fixing roller 1 enters the nip portion N and contacts with the recording medium P at time t=0. After that, as the point p1 moves within the nip portion N and time elapses as t1, t2 and t3, the temperature distribution of the recording medium P and the fixing roller 1 is gradually smoothed. Here, the recording medium P and the fixing roller 1 are assumed to be semi-infinite solids. Although the recording medium P and the fixing roller 1 are not semi-infinite solids, they may be regarded as semi-infinite solids because a time during which the point p1 of the fixing roller 1 stays at the nip portion N is short and a range affected by heat during the stay is limited to a superficial area thereof.

As shown in FIG. 3B, non-stationary heat conduction occurs within the fixing roller 1, and the temperature changes every moment. While an interfacial temperature between the fixing roller 1 and the recording medium P at the point p1 is constant at the temperature Tb, the average temperature of the fixing roller 1 side gradually drops as the temperature distribution becomes smooth, so that a heat flow rate from the fixing roller 1 to the recording medium P decreases. If the average temperature is too low, there is a possibility that capacity of the fixing roller 1 heating the recording medium P becomes insufficient and the toner image is insufficiently melted and fixed.

The temperature distribution within the fixing roller 1 is a function of the time t from the contact and the position x in the depth direction. The position x is a coordinate system with an origin located at a contact interface between the fixing roller 1 and the toner image. The non-stationary changes of the temperature within the fixing roller 1 can be found by the following equation by solving a non-stationary heat conduction equation by setting a condition in which the interfacial temperature of the fixing roller 1 whose initial temperature has been Th is fixed to Tb as a boundary condition:

$$\begin{matrix}{T}_{h} ( t , x ) = {T}_{h} - ( {T}_{h} - {T}_{b} ) erfc ( \frac{x}{2 \sqrt{{α}_{h} t}} ) & Eq . 2 \\ \begin{matrix}x = 2 \sqrt{{α}_{h} t} ⇒ {T}_{h} ( t , x ) \\ = {T}_{h} - ( {T}_{h} - {T}_{b} ) erfc ( 1 ) \\ = {T}_{h} - ( {T}_{h} - {T}_{b} ) 0.16\end{matrix} & Eq . 3\end{matrix}$$

Here, “erfc” in Equation 2 denotes a complementary error function, and αₕ[m²/sec] denotes thermal diffusivity of an outer surface layer of the fixing roller 1. x in Equation 3 represents a depth from the contact interface where the temperature Tₕ of the fixing roller 1 changes by 16% to the boundary temperature T_{b} in the contact time t. This depth of permeation of the change of the temperature distribution will be referred to as a thermal diffusive length L. This is used in the field of the heat conduction engineering in general as an index of a range of influence of temperature when the non-stationary heat conduction occurs.

L≡2\sqrt{αt} Eq. 4

A heat flux q[W/m²] flowing from the fixing roller into the recording medium P by the non-stationary heat conduction expressed by Equation 2 can be obtained as follows:

$$q = \frac{{b}_{h}}{\sqrt{π t}} ( {T}_{h} - {T}_{b} )$$

$${b}_{h} = \sqrt{{λ}_{h} ρ {C}_{h}}$$

where,

bₕ[J/(m²·K·s^{0.5})] is thermal permeability of the outer release layer of the fixing roller,

λₕ[W/(m·K)] is thermal conductivity of the surface layer of the fixing roller, and

ρCₕ[J/(m³·K)] is heat capacity of the release layer of the fixing roller. . . . Eq. 5

As it is apparent from Equation 5, the greater the thermal permeability bₕ of the outer surface layer of fixing roller, the more readily the fixing roller 1 can apply thermal energy to the recording medium P. As a result, it is possible to melt and fix the toner efficiently. Still further, because there is a positive correlation between a quantity of heat applied to the recording medium P and fixability of the toner, it is possible to lower the temperature of the fixing roller 1 while maintaining the toner fixability by using a material having large thermal permeability bₕ for the surface layer of the fixing roller 1.

As described above, the thermal diffusive length L serves as an index indicating the range of influence of temperature when the non-stationary heat conduction occurs and the thermal permeability bₕ serves as an index indicating capacity of a substance giving and taking energy.

### (Study on Influence of Thickness)

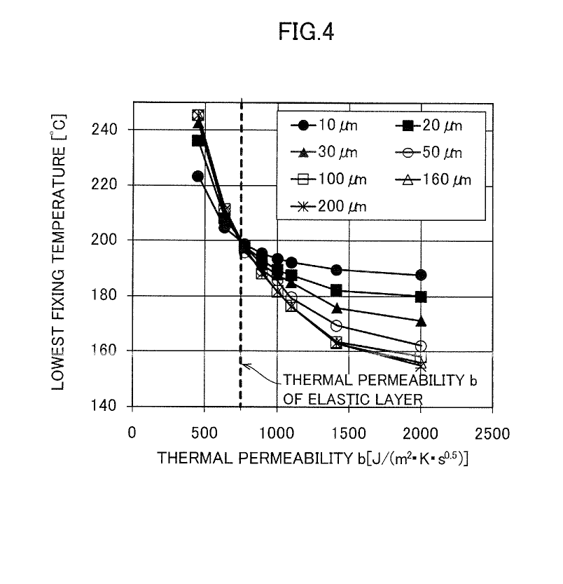

FIG. 4 is a graph indicating results of study implemented on a thicknesses of the release layer.

As shown in Table 1, an influence of the thermal permeability b on a lowest toner fixing temperature was studied by studying the toner fixability by varying the thickness d and the thermal permeability b (thermal conductivity λₕ here) of the release layer 1a of the fixing roller 1 to study a fixing condition effective for lowering the target temperature in the temperature control of the fixing roller 1.

TABLE 1

| | | THERMAL | | THERMAL |
|---|---|---|---|---|
| | THICKNESS | CONDUCTIVITY | HEAT CAPACITY | PERMEABILITY |
| | d [μm] | λ [W/(m · K)] | ρC [J/(m³ · K)] | b [J/(m² · K·s^{0.5})] |
| ELASTIC LAYER | 200 | 0.3 | 1.86 × 10⁶ | 747 |
| RELEASE LAYER | 10~200 | 0.1~2.0 | 2.0 × 10⁶ | 447~2000 |

The lowest toner fixing temperature is an outer surface temperature of the fixing roller 1 just before the nip portion at least required to exceed 90% of toner residual ratio on the recording medium after a destruction test carried out by applying a predetermined amount of bending and friction on a fixed image.

As described in “Basics and Application of Electrophotographic Technology” 1988, Corona Publishing Co., Ltd., pp. 192 to 210, the toner fixability is correlated with fixing strength expressed by a function of a pressing force, a nip portion passing time, and toner viscosity at the nip portion. On a basis of such correlation, the toner fixability was evaluated and the lowest fixing temperature in each fixing condition was found by estimating the toner temperature (viscosity) at the nip portion N from simulations of a heat conduction reflecting the fixing conditions.

As shown in FIG. 4, the greater the thermal permeability b of the release layer, the lower the lowest fixing temperature can be. An axis of abscissa in FIG. 4 represents the thermal permeability b of the release layer 1a of the fixing roller 1 and an axis of ordinate represents the lowest toner fixing temperature. This happens because the greater the thermal permeability b, the more efficiently the thermal energy is applied to the toner.

When the fixing conditions are compared in terms of the thickness d of the release layer, a tendency of the thickness d of the release layer advantageous for lowering the lowest fixing temperature is switched about the thermal permeability b of the elastic layer (broken line in FIG. 4) and there exists a clear threshold value. That is, it is advantageous for lowering the lowest fixing temperature when the thickness d of the release layer is thin in a range in which the thermal permeability b of the elastic layer is greater than the thermal permeability b of the release layer. In contrary, it is advantageous for lowering the lowest fixing temperature when the thickness d of the release layer is thick in a range in which the thermal permeability b of the elastic layer is smaller than the thermal permeability b of the release layer.

### (Study on Influence of Thermal Diffusion Length)

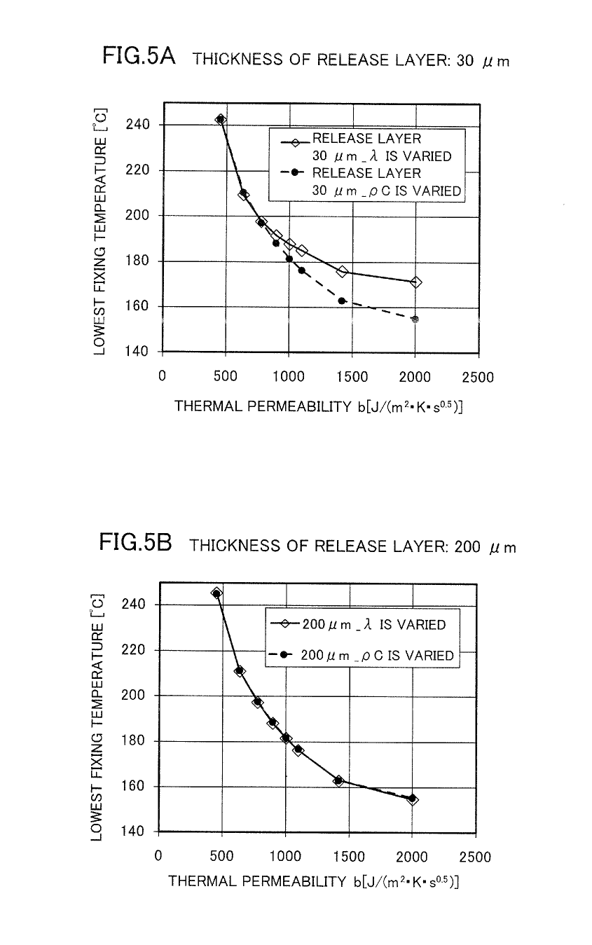

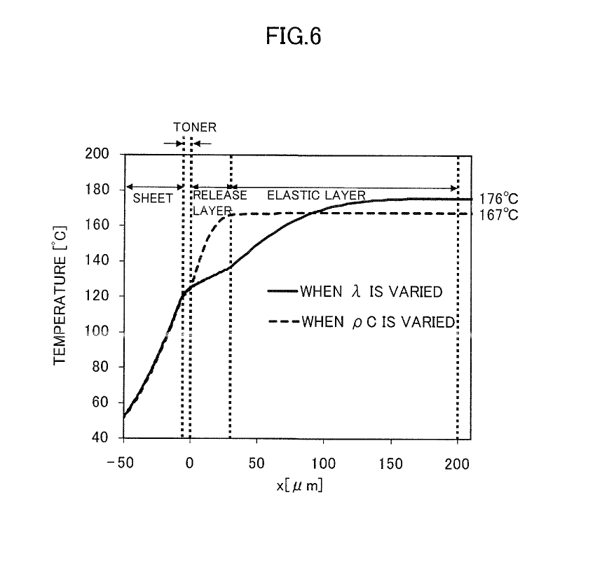

FIGS. 5A and 5B are graphs explaining study results on the thermal diffusion length of the release layer, and FIG. 6 is a graph explaining a temperature distribution in the depth direction in a case where the thickness of the release layer is 30 μm.

As shown in Table 2, the toner fixability was studied by varying the thermal conductivity λ and the heat capacity ρC of the release layer 1a of the fixing roller 1 in cases where the thickness of the release layer 1a was 30 μm and 200 μm to study an influence of the thermal diffusion length L to the lowest toner fixing temperature and a fixing condition effective for lowering the target temperature in the temperature control of the fixing roller 1.

TABLE 2

| | | THERMAL | | THERMAL |
|---|---|---|---|---|
| | THICKNESS | CONDUCTIVITY | HEAT CAPACITY | PERMEABILITY |
| | d [μm] | λ [W/(m · K)] | ρC [J/(m³ · K)] | b [J/(m² · K · s^{0.5})] |
| ELASTIC LAYER | 200 | 0.3 | 1.86 × 10⁶ | 747 |
| RELEASE LAYER | 30, 200 | 0.1 | 2.0 × 10⁶~40 × 10⁶ | 447~2000 |

As shown in FIG. 5B, in the case where the thickness d of the release layer 1a is 200 μm, the greater the thermal permeability b of the release layer, the lower the lowest fixing temperature becomes. The lowest fixing temperature is equal even in a case where the thermal conductivity λ is increased or the heat capacity ρC is increased to increase the thermal permeability b of the release layer. Even if the thermal conductivity λ is increased in the case where the release layer 1a is thick, it does not affect the thermal permeability b of the elastic layer 1b, so that the effect of the increase of the thermal permeability b of the release layer 1a appears significantly and the lowest fixing temperature can be fully lowered.

In the case where the thickness d of the release layer 1a is 30 μm as shown in FIG. 5A, the greater the thermal permeability b of the release layer, the lower the lowest fixing temperature becomes. In a case where the thermal conductivity λ, is increased to increase the thermal permeability b of the release layer 1a, the lowest fixing temperature rises as compared to a case where the heat capacity ρC is increased. In the case where the release layer 1a is thin, the influence of the thermal permeability b of the elastic layer 1b becomes significant when the thermal conductivity λ is increased, so that the effect of the increase of the thermal permeability b of the release layer is lessened and the lowest fixing temperature cannot be fully lowered.

As shown in FIG. 6, when the thickness d of the release layer 1a is 30 μm and the thermal permeability b is 1400[J/m²·K·sec^{0.5}]], a temperature distribution appears as indicated by a solid line in the case where the thermal conductivity λ is increased and a temperature distribution appears as indicated by a broken line in the case where the heat capacity ρC is increased. Because the time t passing through the nip portion N is 10 msec, a temperature distribution in the depth x direction at the moment when the surface of the fixing roller 1 is cooled by 10 msec is compared. The fixability of the toner image is equal in the both cases where the thermal conductivity λ is increased and the heat capacity ρC is increased because the temperature distribution on the recording medium side is equal.

However, on the fixing roller 1 side, the temperature distribution differs considerably in the cases where the heat capacity ρC is increased (broken line) and the thermal conductivity λ is increased (solid line). In the case where the heat capacity ρC is increased, because the thermal diffusion length L is 30 μm, a depth influenced by the cooling during 10 msec in which the fixing roller 1 passes through the nip portion N is kept substantially within 30 μm of the thickness of the release layer 1a. However, in the case where the thermal conductivity λ is increased, because the thermal diffusion length L is 150 μm, a depth influenced by the cooling during 10 msec in which the fixing roller 1 passes through the nip portion N affects the elastic layer 1b beyond the release layer 1a.

### (Problem of Power Consumption)

As shown in FIG. 6, in a case where the thermal conductivity λ is increased, the target temperature of the temperature control of the fixing roller 1 necessary to obtain the equal fixability is 176° C. and is higher than 167° C. in the cases where the heat capacity ρC is increased and the thickness of the release layer 1a is 200 μm. That is, in order to equally assure the fixability of the same output image, the outer surface temperature of the fixing roller 1 must be kept high when the thickness of the release layer 1a is 30 μm as compared to the case when the thickness of the release layer 1a is 200 μm. If the outer surface temperature of the fixing roller 1 is kept high, radiation of heat of the fixing roller 1 is intensified, so that a power consumption increases. Thermal deterioration of the respective layers of the fixing roller 1 also accelerates if the outer surface temperature of the fixing roller 1 is kept high.

### (Lower Limit Value of Thickness of Release Layer)

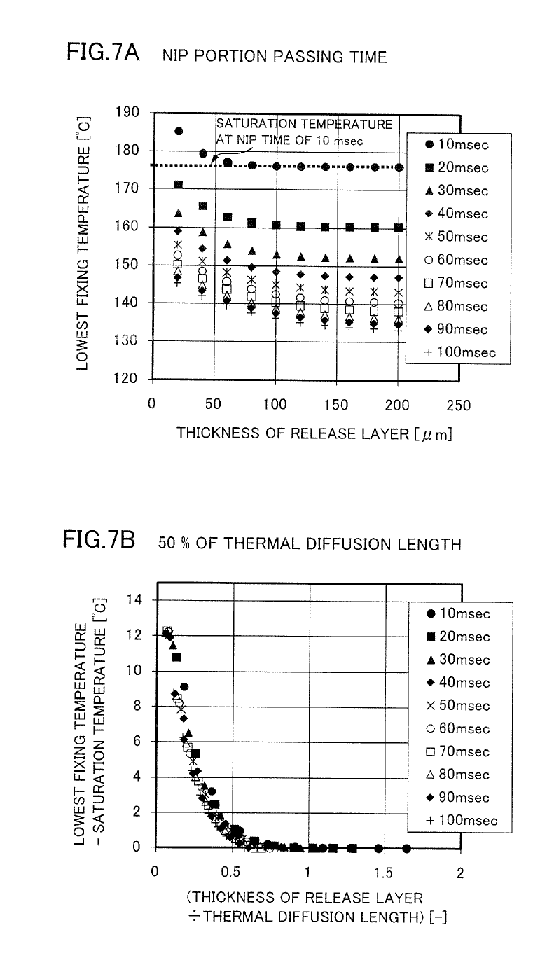

FIGS. 7A and 7B are graphs explaining the relationship between the thickness of the release layer and the lowest fixing temperature.

As shown in Table 3, the nip portion passing time t and the thickness of the release layer 1a were varied to evaluate the fixability of the output image as described above and to study their lowest fixing temperature. On a basis of experimental results, a relationship among the lowest fixing temperature, thermal diffusion length L, the thickness d of the release layer 1a, and the nip portion N passing time t was generalized.

TABLE 3
NIP TIME [msec] 10~100

| | | THERMAL | | THERMAL |
|---|---|---|---|---|
| | THICKNESS | CONDUCTIVITY | HEAT CAPACITY | PERMEABILITY |
| | d [μm] | λ [W/(m · K)] | ρC [J/(m³ · K)] | b [J/(m² · K · s^{0.5})] |
| ELASTIC LAYER | 200 | 0.3 | 1.86 × 10⁶ | 747 |
| RELEASE LAYER | 10~200 | 0.6 | 2.0 × 10⁶ | 1095 |

As shown in FIG. 7A, the lowest fixing temperature saturates to a predetermined temperature around where the thickness of the release layer 1a exceeds the thermal diffusion length L in every nip portion passing time t. Then, the saturated predetermined temperature was subtracted from the data of the lowest fixing temperature regarding the respective nip portion passing times 10 to 100 msec to standardize and to express the data of all nip portion passing times t as one graph.

As shown in FIG. 7B, the tendency of the lowest fixing temperature can be consolidated by the thermal diffusion length L even when the nip portion passing time t is different. Still further, the lowest fixing temperature reaches a saturation temperature actually around where the thickness of the release layer 1a exceeds 50% of the thermal diffusion length L. Due to that, the heat transfer characteristic of the release layer 1a can be fully used by making the thickness d of the release layer 1a as expressed by the following equation in which the thickness d of the release layer 1a is 50% or more of the thermal diffusion length L, where α [m²/sec] is the thermal diffusivity of the release layer 1a and t [sec] is the recording medium stay time in the nip portion N:

\sqrt{αt}≦d Eq. 6

Here, a case where the fixing roller 1 has a n layer structure will be generalized and expressed. That is, the fixing roller 1 is assumed to have a multi-layer structure of n layers in total in which the layers are denoted by layer numbers in order from 1 from the layer of the heat source side to the surface layer in contact with the recording medium. Then, a n^{th} layer in bₙ>bₙ₋₁ is formed to have a thickness do expressed by the following equation, where bⱼ is thermal permeability of a j^{-th} (j=1 to n) layer, αⱼ is thermal diffusivity, dⱼ is a thickness, and t is a recording medium stay time in the nip portion N.

\sqrt{αₙt}≦dₙ Eq. 7

No matter how many layers the heating member includes, the exchange of the quantity of heat between the heating member and the recording medium at the nip portion N follows basically to Equation 2, and even if the number of layers is generalized into the n layer structure, the thickness of the release layer can be defined with the similar relationship as described in Equation 7.

Although there is a case where there is a primer layer as an adhesive layer between the layers, normally the primer layer is ignored as a layer because the primer layer is fully thin as compared to the elastic layer and the release layer. That is, the present invention which primarily notices on the quantity of exchanged heat at the respective layers does not consider the primer layer as a layer number because a thermal contribution of the primer layer is small. Therefore, the primer layer is not considered as a layer hereinafter.

Still further, while, depending on a formation process of the elastic layer, there is a case where a skin layer having a different quantity of dispersed filler from that in a bulk of the elastic layer is formed on the surface or the interface with the elastic layer, the skin layer is ignored as a layer because a thickness of the skin layer is fully thin as compared to the thickness of the elastic layer. That is, the present invention which primarily notices on the quantity of exchanged heat at the respective layers does not consider the skin layer as a layer number because a thermal contribution of the skin layer is small. Therefore, the skin layer is not also considered as a layer hereinafter.

### (Upper Limit Value of Thickness of Releasing Layer)

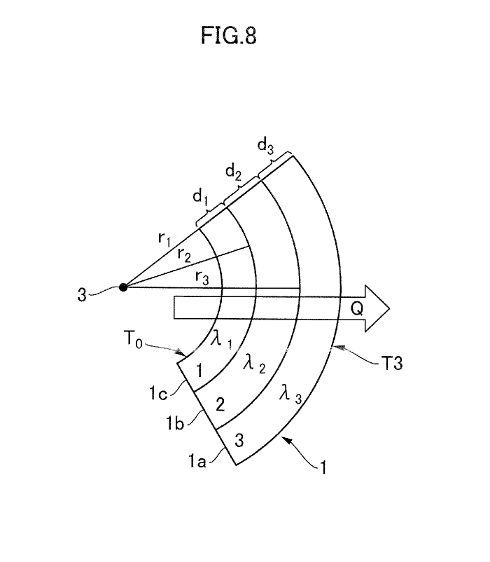

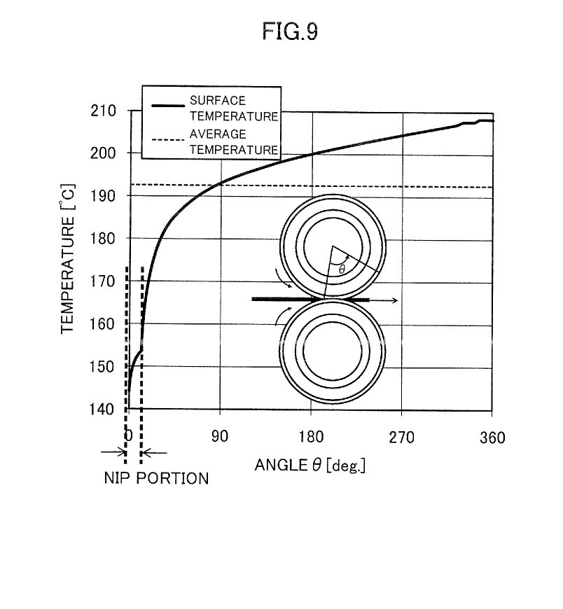

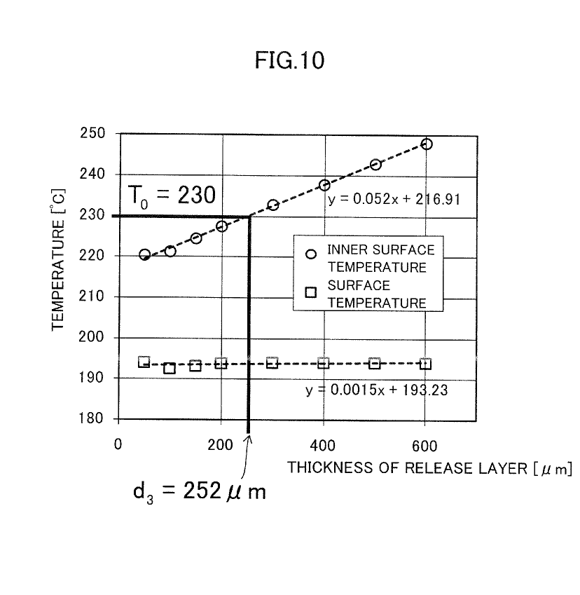

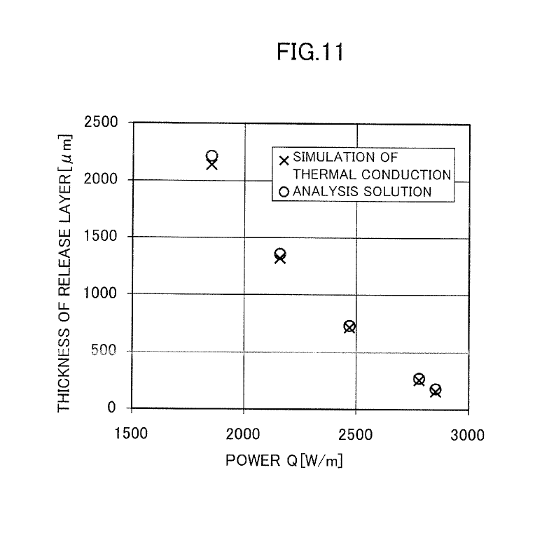

FIG. 8 is a diagram explaining a parameter of each layer of the fixing roller 1, FIG. 9 is a graph explaining changes of the outer surface temperature in one rotation of the fixing roller 1, FIG. 10 is a graph explaining an upper limit value of the thickness of the release layer, and FIG. 11 is a graph explaining a relationship between a supply power and the maximum allowable thickness of the release layer.

As shown in FIG. 8, the thickness d₃ of the release layer 1a should be designed on the basis of the relationship of Equation 4 in order to fully utilize the heat transfer characteristic of the release layer 1a. However, if the thickness of the release layer 1a is increased, a total heat resistance of the fixing roller 1 increases and there is a possibility that the temperature of the elastic layer 1b exceeds a heat resistant temperature. Then, it is necessary to define an upper limit value of the thickness d₃ of the release layer 1a so that a temperature of each layer of the fixing roller 1 does not exceed respective heat resistant temperature even in an operation state in which a quantity of heat of the halogen lump 3 is maximized. A time when a temperature difference is maximized between temperatures of an inner circumferential surface and an outer circumference of the fixing roller 1 and when the temperature of the inner circumferential surface is high is a time when images are formed continuously by zeroing intervals between the images. Then, it is considered that no problem occurs under other fixing conditions if the thickness d₃ of the release layer 1a is set such that a temperature of each layer of the release layer 1a goes under the heat resistant temperature even in forming images continuously as described above.

As shown in FIG. 8, radiant energy of the halogen lump 3 inputted from a center of the fixing roller 1 transmits radially from inside to outside of each layer of the fixing roller 1. The fixing roller 1 is composed of the base layer 1c, the elastic layer 1b and the release layer 1a from inside to outside. Numbers j will be assigned to the respective layers from the layer on the heat source side to the surface side coming into contact with a recording medium as j=1: the base layer 1c, j=2: the elastic layer 1b, and j=3: the release layer 1a. An inner diameter of each layer will be denoted as rⱼ (j=1 to 3), a thickness as dⱼ (j=1 to 3), and thermal conductivity as λⱼ (j=1 to 3). A temperature of an outer circumferential surface of each layer will be denoted as Tⱼ (j=1 to 3), and a temperature of an inner circumferential surface of an innermost layer will be denoted as T₀. A length in a sheet depth direction of the fixing roller 1 will be denoted as 1[m], and an electric power (referred to simply as a “power” hereinafter) per unit length radiated from the halogen lump 3 will be denoted as Q [W/m]. This state can be modeled as a steady heat transfer phenomenon of a cylindrical material.

When the power Q [W/m] is applied from the center of the cylindrical fixing roller 1, a relationship expressed by Equation 8 holds between the temperature T₀ of the inner circumferential surface of the innermost layer and the temperature d₃ of the outer circumferential surface in contact with the recording medium P. It is possible to obtain Equation 9 by solving Equation 8 as to the thickness d₃ of the release layer 1a.

$$Q = \frac{2 π}{\frac{1}{{λ}_{1}} ln \frac{{r}_{2}}{{r}_{1}} + \frac{1}{{λ}_{2}} ln \frac{{r}_{3}}{{r}_{2}} + \frac{1}{{λ}_{3}} ln \frac{{r}_{3} + {d}_{3}}{{r}_{3}}} ( {T}_{0} - {T}_{3} )$$

where,

r_{1˜3}[m] are inner diameters of base, elastic and release layers,

d_{1˜3}[m] are thicknesses of base, elastic and release layers,

λ_{1˜3}[W/(m·K)] are thermal conductivities of base, elastic and release layers,

T_{1˜3}[° C.] are temperatures of outer circumferential surfaces of base, elastic and release layers, and

T₀[° C.] is temperature of the inner circumferential surface of the base layer. . . . Eq. 8

$${d}_{3} = {r}_{3} [ exp \{ {λ}_{3} [ \frac{2 π}{Q} ( {T}_{0} - {T}_{3} ) - \frac{1}{{λ}_{1}} ln \frac{{r}_{2}}{{r}_{1}} - \frac{1}{{λ}_{2}} ln \frac{{r}_{3}}{{r}_{2}} ] \} - 1 ] \qquad Eq . 9$$

The temperature T₀ of the inner circumferential surface of the innermost layer is highest in the fixing roller 1 because the inner circumferential surface is closest to the halogen lump 3, i.e., the heat source. Therefore, it is possible to eliminate the problem of the heat resistance of the fixing roller 1 by designing the thickness of the release layer 1a to be less than a thickness which makes the temperature T₀ of the inner circumferential surface of the fixing roller 1 lower than a heat resistant limit temperature on a basis of Equation 9.

By the way, because the second layer, i.e., the elastic layer 1b, is questioned in terms of the heat resistance in the case where the first layer is the metallic base layer 1c, it is necessary to design the thickness of the release layer 1a such that the temperature T₁ of the elastic layer 1b is lower than the heat resistant limit temperature of the elastic layer 1b. However, because thermal conductivity of metal is very large and there is barely no temperature distribution within the metallic layer, i.e., substantially, T₁≈T₀, the thickness of the release layer 1a should be designed such that the temperature T₀ is lower than the heat resistant limit temperature of the elastic layer 1b.

It is also possible to design in the same manner even when a layer structure is changed by adding a layer by applying Equation 9.

Here, a case where the fixing roller 1 is composed of n layers will be generalized and expressed. That is, the fixing roller 1 is assumed to have a multi-layer structure of n layers in total in which layer No. is assigned to each layer in order from 1 to the layer on the heat source side to the surface layer in contact with the recording medium. A thickness of a n^{-th} layer is set as expressed by the following equation, where rⱼ is an inner diameter of a j^{-th} (j=1 to n) layer, dⱼ is a thickness thereof, λⱼ is thermal conductivity, Tⱼ is a temperature of an outer circumferential surface of the j^{-th} layer, and T₀ is a temperature of an inner circumferential surface of the first layer:

$${d}_{n} = {r}_{n} [ exp \{ {λ}_{n} [ \frac{2 π}{Q} ( {T}_{0} - {T}_{n} ) - {\sum }_{j = 1}^{n - 1} \frac{1}{{λ}_{j}} ln \frac{{r}_{j + 1}}{{r}_{j}} ] \} - 1 ]$$

where,

rⱼ[m] is an inner diameter of a j^{-th} layer,

dⱼ[m] is a thickness of the j^{-th} layer,

λⱼ[W/(m·K)] is thermal conductivity of the j^{-th} layer,

Tⱼ[° C.] is a temperature of an outer circumferential surface of the j^{-th} layer, and

T₀[° C.] is a temperature of an inner circumferential surface of the j^{-th} layer. . . . Eq. 10

As shown in Table 4, regarding the fixing apparatus 10 shown in FIG. 2, the temperature T₀ of the inner circumferential surface of the fixing roller 1 was evaluated by setting the thickness and thermal physical properties of each layer of the fixing roller 1 and by carrying out a heat conduction simulation by modeling the fixing roller 1 by a two-dimensional section. That is, a relationship between thicknesses d₁, d₂ and d₃ of the respective layers of the fixing roller 1 and the temperature T₀ of the inner circumferential surface of the fixing roller 1 by varying the thickness of the release layer 1a of the fixing roller 1 was studied.

TABLE 4

| | | | THERMAL | | THERMAL |
|---|---|---|---|---|---|
| | | THICKNESS | CONDUCTIVITY | HEAT CAPACITY | PERMEABILITY |
| | | d [μm] | λ [W/(m · K)] | ρC [J/(m³ · K)] | b [J/(m² · K · s^{0.5})] |
| FIXING | BASE LAYER | 1000 | 90 | 4.0 × 10⁶ | 18974 |
| ROLLER | ELASTIC LAYER | 200 | 0.3 | 1.86 × 10⁶ | 747 |
| | RELEASE LAYER | 50~600 | 0.6 | 2.0 × 10⁶ | 1095 |
| TONER | TONER | 5 | 0.3 | 1.8 × 10⁶ | 735 |
| IMAGE | PAPER | 115 | 0.12 | 1.2 × 10⁶ | 379 |
| PRESSURE | RELEASE LAYER | 50 | 0.2 | 2.3 × 10⁶ | 678 |
| ROLLER | ELASTIC LAYER | 200 | 0.3 | 1.86 × 10⁶ | 747 |
| | METALLIC | 1000 | 90 | 4.0 × 10⁶ | 18974 |
| | BASE LAYER | | | | |

As shown in a graph in FIG. 9, changes of the outer surface temperature of one rotation of the fixing roller 1 in a stationary state was simulated when a power Q=2778[W/m] and the thickness d₃ of the release layer 1a=50 μm. The stationary state is a state in which a continuous sheet (image interval=0) is fixed until when the changes of the outer surface temperature of one rotation of the fixing roller 1 are constantly repeated. An axis of abscissa of the graph represents a rotational angle from a position where a recording medium starts to enter the nip portion N, and an axis of ordinate represents a temperature at one point on the surface of the fixing roller 1.

While Equation 9 describes a state in which the steady heat conduction phenomenon is generated isotropically in the rotational direction strictly in a cylindrical system as shown in FIG. 8, actually the fixing roller 1 repeats cycles of cooling and re-heating of the outer surface temperature as shown in FIG. 9. Then, an outer surface temperature T₃ was taken as an average value of the outer surface temperature here:

T₃=\hat{T}₃(outer surface average temperature)

where, \hat{T}₃ is an average value of outer surface temperatures T₃, and

\hat{T}₀ is an average value of an inner surface temperature of fixing roller. . . . Eq. 11

Here, the halogen lump 3 heats the whole in the rotational direction of the fixing roller 1 homogeneously. An operation condition is set such that an average temperature of the inner circumferential surface of the fixing roller 1 is less than a heat resistant temperature of a n−1^{th} layer of the fixing roller 1. At this time, the temperature T₀ of the inner surface of the fixing roller 1 is substantially at a constant value of 220° C. around the fixing roller 1 because the thermal conductivity of metal is large, and is substantially equal to the average value of the temperatures T₀ of the inner surface of the fixing roller 1. Then, a simulation of heat conduction of the average values of the inner surface and the surface of the fixing roller 1 was carried out by varying the thickness d of the release layer 1a from 50 to 600 μm in this state as shown in FIG. 10.

As shown in FIG. 10, the average temperatures of the inner surface and the surface of the fixing roller 1 have both linear relationships with the thickness d (d₃) of the release layer 1a. Accordingly, the thickness d (d₃) of the release layer 1a must be less than 252 μm if the heat resistant temperature of the rubber of the elastic layer 1b is assumed to be 230° C.

Next, a study on a similar heat conduction simulation was carried out under conditions of other ordinary power Q and a maximum allowable thickness (marks x) of the release layer 1a for keeping the temperature T₀ of the inner circumferential surface of the fixing roller 1 below 230° C. was found as shown in FIG. 11.

As shown in FIG. 11, it was found that results of the heat conduction simulation (marks x in FIG. 11) of the heat conduction coincide very well with analytical solutions (mark o in FIG. 11) obtained on a basis of Equation 4 described above. Accordingly, even if the outer surface temperatures of the fixing roller 1 are inhomogeneous, it is possible to estimate the thickness of the release layer 1a by Equation 9 by using an average value of the outer surface temperatures as a thermal typical value.

Then, it is possible to keep the temperature of the inner circumferential surface below the heat resistant limit temperature of the fixing roller 1 while fully utilizing the heat transfer characteristic of the release layer 1a by defining the thickness d₃ of the release layer 1a of the fixing roller 1 as described by the following Equation 12 in which Equations 6 and 9 are combined:

$$\sqrt{{α}_{3} t} < {d}_{3} < {r}_{3} [ exp \{ {λ}_{3} [ \frac{2 π}{Q} ( {\hat{T}}_{0} - {\hat{T}}_{3} ) - {\sum }_{j = 1}^{2} \frac{1}{{λ}_{j}} ln \frac{{r}_{j + 1}}{{r}_{j}} ] \} - 1 ] \qquad Eq . 12$$

When the case where the fixing roller 1 is composed of n-layers is generalized, it may be expressed as the following Equation 13 by combining Equation 7 with Equation 10. It is possible to keep the temperature of the inner circumferential surface below the heat resistant limit temperature of the second layer of the fixing roller 1 while fully utilizing the heat transfer characteristic of the n^{-th} layer by defining the thickness dₙ of the n^{-th} layer of the fixing roller 1 as described by the following Equation 13:

$$\sqrt{{α}_{n} t} < {d}_{n} < {r}_{n} [ exp \{ {λ}_{n} [ \frac{2 π}{Q} ( {\hat{T}}_{0} - {\hat{T}}_{n} ) - {\sum }_{j = 1}^{n - 1} \frac{1}{{λ}_{j}} ln \frac{{r}_{j + 1}}{{r}_{j}} ] \} - 1 ] \qquad Eq . 13$$

### (Specific Configuration of First Embodiment)

As shown in FIG. 2, the fixing roller 1 has 300 mm in length and 30 mm in diameter. The elastic layer 1b made of silicone rubber having 200 μm in thickness is formed on the base layer 1c made of iron having 1 mm in thickness in the fixing roller 1. The elastic layer 1b gives flexibility to the fixing roller 1 to regulate the width in the conveying direction of the nip portion N and image quality of an output image by adjusting the thickness and hardness thereof. Elastic modulus of the elastic layer 1b disposed right under the release layer 1a of the fixing roller 1 is smaller than that of the release layer 1a, and a contact angle to melted toner of the surface of the release layer 1a is larger than that of the surface of the elastic layer 1b at a same temperature. Elastic modulus of the n−1^{-th} layer is smaller than that of the n^{th} layer, and a contact angle to melted toner of the surface of the n−1^{-th} layer is smaller than that of the surface of the n^{th} layer at the same temperature.

The surface of the elastic layer 1b is coated by the release layer 1a made of fluoro-rubber having a thickness of 100 μm. Because high thermal conductive inorganic filler is doped in the release layer 1a, so that thermal conductivity of the fluoro-rubber material is enhanced. The high thermal conductive inorganic filler is blended in the release layer 1a of the fixing roller 1 to enhance both the heat capacity and the thermal conductivity per unit volume of the release layer 1a.

The pressure roller 2 is also 300 mm in length and 30 mm in diameter. The elastic layer 2b made of silicone rubber having a thickness of 200 μm is formed on the base layer 2c made of iron having a thickness of 1 mm. The elastic layer 2b is coated by the release layer 2a made of fluoro-resin (PFA) having a thickness of 50 μm. Table 5 shows heat physical property values of the respective layers of the fixing roller 1 and the pressure roller 2.

Density of each layer was measured by means of an immersion method by using a density meter. A specific heat was measured by using a differential scanning calorimeter (DSC), and the heat capacity was found from a product of the density and the specific heat. The thermal conductivity was measured by using ai-Phase Mobile 2 (ai-Phase Co., Ltd.).

TABLE 5

| | | | THERMAL | | THERMAL |
|---|---|---|---|---|---|
| | | THICKNESS | CONDUCTIVITY | HEAT CAPACITY | PERMEABILITY |
| | | d [μm] | λ [W/(m · K)] | ρC [J/(m³ · K)] | b [J/(m² · K · s^{0.5})] |
| FIXING | BASE LAYER | 1000 | 90 | 4.0 × 10⁶ | 18974 |
| ROLLER | ELASTIC LAYER | 200 | 0.3 | 1.86 × 10⁶ | 747 |
| | RELEASE LAYER | 100 | 0.6 | 2.0 × 10⁶ | 1095 |
| PRESSURE | RELEASE LAYER | 50 | 0.2 | 2.3 × 10⁶ | 678 |
| ROLLER | ELASTIC LAYER | 200 | 0.3 | 1.86 × 10⁶ | 747 |
| | BASE LAYER | 1000 | 90 | 4.0 × 10⁶ | 18974 |

The fixing apparatus 10 is arranged such that a pressure of the nip portion N is 0.4 MPa, the width in the rotational direction of the nip portion N is 4 mm, a peripheral velocity of the fixing roller 1 is 400 mm/sec., and a passing time of the nip portion N is 0.004÷0.4=10 msec. The power applied from the halogen lump 3 to the fixing roller 1 is Q=2534[W/m]. A temperature just before the nip portion N of the surface of the fixing roller 1 is about 180° C. when the outer surface temperature of the fixing roller 1 becomes a stationary state in a heating process of a continuous sheet.

As shown in FIG. 7A, the toner on the continuous sheet is fully fixed by the parameters set in the first embodiment because the lowest fixing temperature is 176° C. when the thickness d of the release layer 1a is 100 μm and the passing time of the nip portion N is 10 msec. At this time, the temperature of the inner surface of the fixing roller 1 is 205° C. and is fully lower than a heat resistant temperature of general silicone rubber of 230° C., so that the elastic layer 1b exhibits an enough durability life.

### Effect of First Embodiment

It is necessary to lead the heat from the halogen lump 3 disposed within the fixing roller 1 efficiently toward the surface of the fixing roller 1 which comes in contact with a toner image in order to efficiently fix the non-fixed toner image to a recording medium. That is, it is essential to lower heat resistance from the inside to the surface of the fixing roller 1. It is possible to improve the heat transfer characteristic of the elastic layer 1b by doping the high thermal conductive filler into the elastic layer 1b itself. The high thermal conductive filler improves the thermal conductivity of the elastic layer 1b and the toner on the recording medium is efficiently heated.

In the case where the release layer 1a is layered on the outside of the elastic layer 1b, the release layer 1a acts as a heat resistant layer, so that the effect of the improvement of the high thermal conductivity of the elastic layer 1b cannot be fully utilized depending on a thickness of the release layer 1a. Then, it is conceivable to enhance the thermal conductivity of the release layer 1a by doping the high thermal conductive filler into the release layer 1a. This arrangement makes it possible to improve efficiency of heating the recording medium and to lower the target temperature of the temperature control of the fixing roller 1 while keeping a favorable toner offset performance by the release layer 1a.

However, if the thermal conductivity of the release layer 1a is enhanced, a new problem occurs concerning the thickness of the release layer 1a. In the case where the fixing roller 1 is composed of, from the inside, the base layer 1c, the elastic layer 1b and the release layer 1a and the thermal permeability of the release layer 1a is higher than that of the elastic layer 1b, the heat transfer characteristic of the release layer 1a cannot be fully utilized unless the thickness of the release layer 1a is thicker than 50% or more of the thermal diffusion length L of the release layer 1a. Then, the thermal permeability of the release layer 1a is set to be greater than that of the elastic layer 1b and the thickness d of the release layer 1a is set to be 50% or more of the thermal diffusion length L in the first embodiment. This configuration realizes the efficient toner fixing condition and permits to lower the target temperature in the temperature control of the fixing roller 1.

By the way, if the thickness d of the release layer 1a is thickened blindly by exceeding 50% of the thermal diffusion length L, a total heat resistance of the fixing roller 1 including a heat resistance of the elastic layer 1b increases. As a result, there is a possibility that the heat resistant temperature of the elastic layer 1b exceeds 230° C. if the outer surface temperature of the fixing roller 1 is increased to the temperature necessary for melting the toner. Then, the fixing apparatus 10 of the first embodiment is arranged such that the elastic layer 1b of the fixing roller 1 is used under the heat resistant temperature of 230° C. to prevent the life from being shortened by overheat by largely setting the thermal permeability of the release layer 1a and by setting the upper limit value of the thickness adequately.

### First Comparative Example

the outer surface temperature of the fixing roller is substantially constant in a stationary state even if the thickness d of the release layer 1a is changed as shown in FIG. 10. The thickness d of the release layer 1a was set at 20 μm in a first comparative example. As shown in FIGS. 6 and 7, a mass is insufficient and the release layer 1a cannot exhibit enough heat storage performance with the first comparative example, so that a heat flow rate from the surface of the fixing roller 1 to the toner became insufficient, the toner melted insufficiently, and an output image was fixed insufficiently as a result.

### Second Comparative Example

The outer surface temperature of the fixing roller 1 is substantially constant in the stationary state even if the thickness d of the release layer 1a is changed as shown in FIG. 10. The thickness d of the release layer 1a was set at 600 μm in a second comparative example. In the second comparative example, while the outer surface temperature of the release layer 1a was substantially the same with the first embodiment, the temperature of the inner circumferential surface of the base layer 1c and the elastic layer 2b exceeded 230° C., and the durability life of the fixing roller 1 was remarkably shortened.

### Second Embodiment

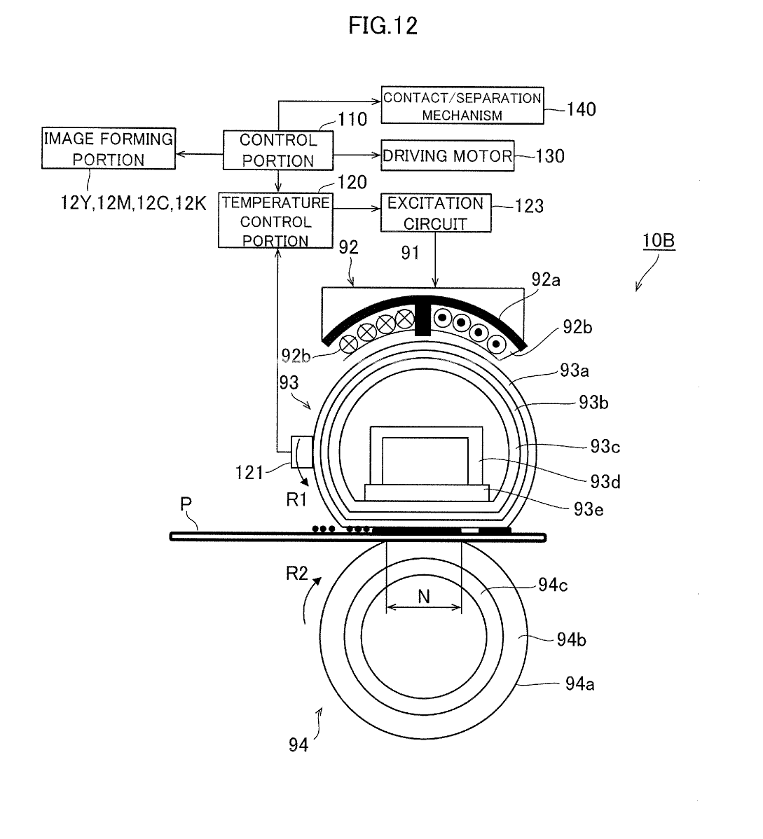

In a second embodiment, the fixing apparatus 10 shown in FIG. 1 is replaced with a fixing apparatus 10B shown in FIG. 12 in the image forming apparatus 100 shown in FIG. 1. The fixing apparatus 10B is a belt fixing apparatus configured to form a nip portion of a recording medium by making a pressure roller 94 in contact with a fixing belt 93.

### (Fixing Apparatus)

FIG. 12 is a schematic diagram explaining a configuration of the fixing apparatus of the second embodiment. As shown in FIG. 1, the fixing apparatus 10B fixes an image to a recording medium P by heating and pressing the recording medium P on which a toner image has been transferred at the secondary transfer portion T2.

As shown in FIG. 12, the fixing apparatus 10B is configured to fix an output image on the recording medium P by pressing and heating the recording medium P at a nip portion N formed between the fixing belt 93 and the pressure roller 94.

The fixing belt 93 is 300 mm in length in a width direction orthogonal to the rotational direction and 30 mm in diameter. The fixing belt 93 is composed of a metallic base layer 93c, an elastic layer 93b made of a rubber material, and a release layer 93a made of a fluoro-rubber material. In the fixing belt 93, the elastic layer 93b made of silicone rubber of 200 μm in thickness is formed around the base layer 93c made of nickel of 0.05 mm in thickness. The elastic layer 93b gives flexibility to the fixing belt 93. It is possible to regulate a length in the rotational direction of the nip portion N and quality of an output image by regulating the thickness and hardness of the elastic layer 93b.

The pressure roller 94 rotates in a direction of an arrow R2 by being driven by the driving motor 130. The fixing belt 93 rotates in a direction of an arrow R1 by being driven by the rotation of the pressure roller 94. The pressure roller 94 is 300 mm in length in the width direction orthogonal to the rotational direction and 30 mm in diameter. In the pressure roller 94, an elastic layer 94b made of silicone rubber of 200 μm in thickness is formed on a base layer 94c made of iron of 1 mm in thickness. A surface of the elastic layer 94b is coated by a release layer 94a made of fluoro-resin (PFA) of 50 μm in thickness.

A pressing stay 93d and a pressing pad 93e are disposed non-rotationally in an inner space of the fixing belt 93. A load is applied to the pressing stay 93d to press the pressing pad 93e to the pressure roller 94 to form the nip portion N between the fixing belt 93 and the pressure roller 94. The pressing pad 93e is 324 mm in length. A pressing mechanism not shown biases both end portions of the pressing stay 93d to apply the load directed to the pressure roller 94 to press the pressing pad 93e toward the fixing belt 93. The nip portion N for the recording medium P is formed between the fixing belt 93 being pressed by the pressing pad 93e and the pressure roller 94. The pressing pad 93e slides an inner circumferential surface of the fixing belt 93. Silicone grease is applied to the inner circumferential surface of the fixing belt 93 to assure slidability between the pressing pad 93e and the inner circumferential surface of the fixing belt 93.

An inductive heating unit 92 is disposed outside of the fixing belt 93. The inductive heating unit 92 generates magnetic fluxes by flowing an electric current through a coil 92b. The temperature control portion 120 feeds power to the coil 92b by controlling an excitation circuit not shown.

A magnetic flux magnetic core 92a guides the magnetic flux generated by the coil 92b in a desired direction and inputs to the fixing belt 93. The coil 92b generates an alternating magnetic flux by an AC current supplied from the excitation circuit. A magnetic field of the alternating magnetic flux generated by the coil 92b is guided by the magnetic core 92a and acts on and generates eddy current in the base layer 93c of the fixing belt 93.

The eddy current generates Joule heat by intrinsic resistance of the base layer 93c. The fixing belt 93 generates heat by an electromagnetic induction action of the generated magnetic flux by supplying the AC current through the coil 92b, so that the fixing belt 93 is inductively heated and the outer surface temperature of the fixing belt 93 rises.

The outer surface temperature of the fixing belt 93 is detected by a temperature sensor 121. The temperature sensor 121 inputs electrical information regarding the detected temperature to a temperature control portion 120. On a basis on the temperature information from the temperature sensor 121, the temperature control portion 120 controls the AC current to be supplied to the coil 92b such that the temperature of the fixing belt 93 is kept at the target temperature (fixing temperature) in the temperature control thereof. That is, the temperature control is made by the temperature control portion 120 such that temperature of the fixing belt 93 rises to the fixing temperature set in advance by controlling the power supplied to the coil 92b from the excitation circuit not shown.

### (Explanation of Parameter of Heating Belt)

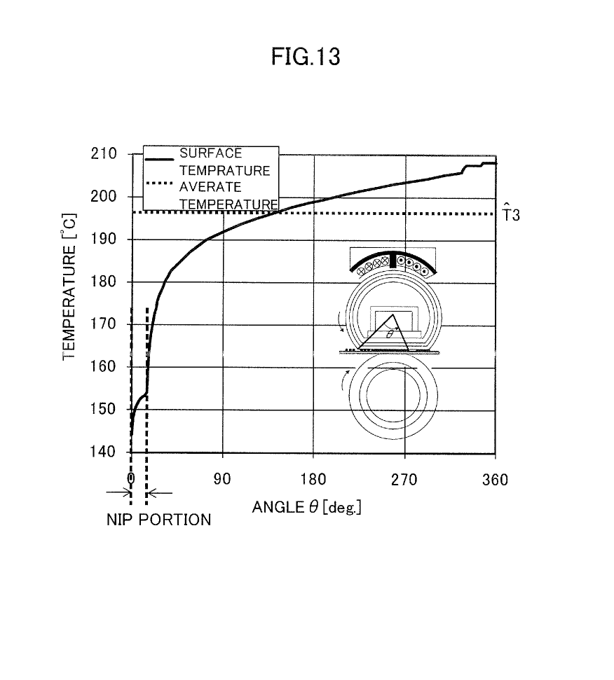

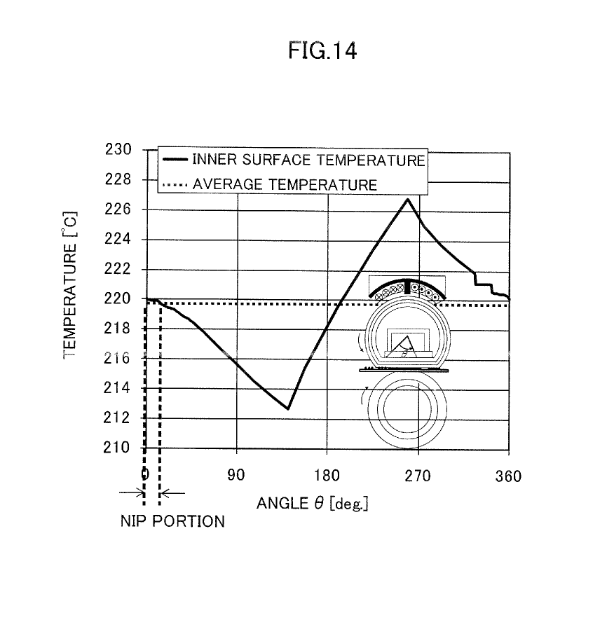

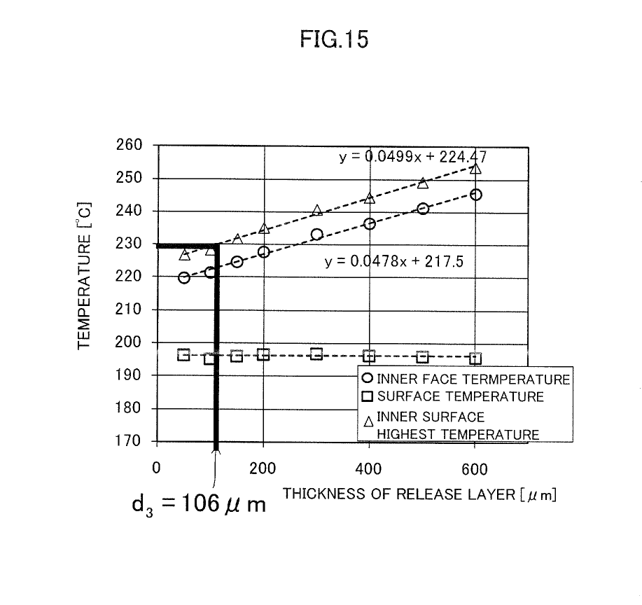

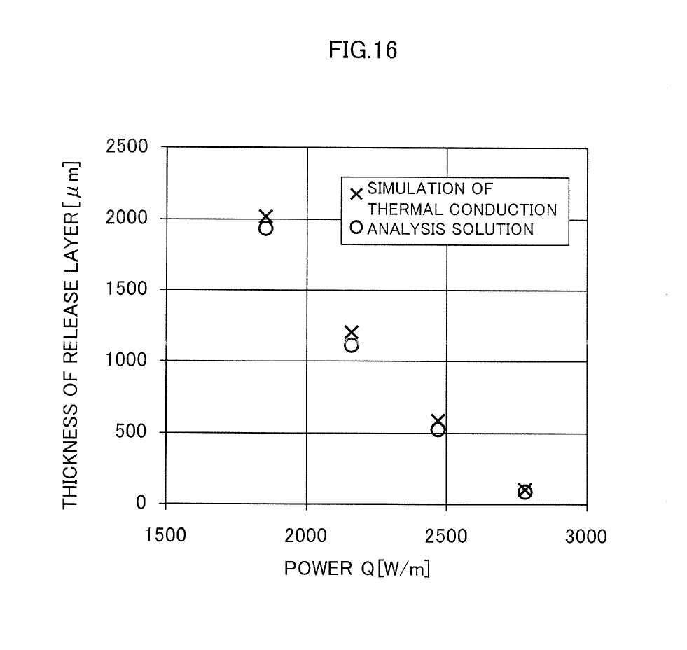

FIG. 13 is a graph explaining changes of an outer surface temperature in one rotation of the fixing belt, FIG. 14 is a graph explaining changes of an inner surface temperature in one rotation of the fixing belt, FIG. 15 is a graph explaining an upper limit value of a thickness of the release layer, and FIG. 16 is a graph explaining a relationship between a supply power and a maximum allowable thickness of the release layer.

As shown in a graph in FIG. 13, a pattern of changes of the outer surface temperature of the fixing belt in a state in which the changes of the outer surface temperature of the fixing belt 93 are put into a stationary state was simulated in terms of thermal conduction. When a power Q was 2778[W/m] and a thickness d of the release layer 93a was 100 μm, a continuous sheet (image interval=0) was heated such that the changes of the outer surface temperature of the fixing belt 93 are constantly repeated in the state. An axis of abscissa of the graph represents a rotational angle from a head position of the nip portion N and an axis of ordinate represents the outer surface temperature of the fixing belt 93. A broken line is an average value of the outer surface temperature in one rotation.

As shown in FIG. 14, a pattern of changes of the inner surface temperature of the fixing belt 93 in a state in which the changes of the outer surface temperature of the fixing belt 93 are put into the stationary state was simulated in terms of thermal conduction. The conditions were the same with those in FIG. 13. An axis of abscissa of the graph represents a rotational angle from a head position of the nip portion and an axis of ordinate represents the inner surface temperature of the fixing belt 93. A broken line is an average value of the inner surface temperature similarly to the case of the outer surface temperature.

As shown in FIG. 15, a relationship between the thickness d of the release layer 93a of the fixing belt 93 and the inner surface temperature of the fixing belt 93 was studied. Table 6 shows layer structures and thermal physical property values of the fixing belt 93 and the pressure roller 94. As shown in Table 6, the simulation of the thermal conduction was studied by varying the thickness of the release layer 93a from 50 to 600 μm. The layer structure of the pressure roller 94 is the same with that shown in Table 4.

TABLE 6

| | | | THERMAL | | THERMAL |
|---|---|---|---|---|---|
| | | THICKNESS | CONDUCTIVITY | HEAT CAPACITY | PERMEABILITY |
| | | d [μm] | λ [W/(m · K)] | ρC [J/(m³ · K)] | b [J/(m² · K · s^{0.5})] |
| FIXING | BASE LAYER | 50 | 75 | 4.7 × 10⁶ | 18775 |
| ROLLER | ELASTIC LAYER | 200 | 0.3 | 1.86 × 10⁶ | 747 |
| | RELEASE LAYER | 50~600 | 0.6 | 2.0 × 10⁶ | 1095 |
| TONER | TONER | 5 | 0.3 | 1.8 × 10⁶ | 735 |
| IMAGE | PAPER | 115 | 0.12 | 1.20 × 10⁶ | 379 |
| PRESSURE | RELEASE LAYER | 50 | 0.2 | 2.3 × 10⁶ | 678 |
| ROLLER | ELASTIC LAYER | 200 | 0.3 | 1.86 × 10⁶ | 747 |
| | METALLIC BASE | 1000 | 90 | 4.0 × 10⁶ | 18974 |
| | LAYER | | | | |

As shown in FIG. 15, both the inner surface average temperature and the outer surface average temperature of the fixing belt 93 hold a linear relationship to the thickness d of the release layer 93a. However, because the inductive heating unit 92 inductively heats the base layer 93c partially in a predetermined angular range in one rotation of the fixing belt 93 as shown in FIG. 12, the fixing belt 93 is partially exposed to a temperature considerably higher than the inner surface average temperature as shown in FIG. 14. Due to that, a thermal conduction simulation was carried out also on a maximum temperature of the inner surface temperature shown in FIG. 14 to confirm that a linear relationship holds to the thickness d of the release layer 93a.

Accordingly, in the second embodiment, the thickness of the release layer required to keep the temperature of the fixing belt 93 below the heat resistant temperature was estimated based on the linear relationship of the maximum temperature of the inner surface temperature, instead of the linear relationship of the inner surface average temperature of the fixing belt 93. As shown in FIG. 15, the thickness d of the release layer 93a should be set below 106 μm in order to keep the maximum temperature T₀ₘₐₓ of the inner surface temperature below the heat resistant temperature of 230° C. of the silicone rubber.

Such thermal conduction simulations were carried out also in other powers in a range from 1800 to 2800[W/m] to find a maximum allowable thickness of the release layer 93a for keeping the inner surface temperature of the fixing belt 93 below 230° C. as shown in FIG. 16.

As shown in FIG. 16, it was found that simulation results (marks x in FIG. 16) of the heat conduction coincide very well with analytical solutions (marks o in FIG. 16) obtained on a basis of Equation 9 described above in the same manner with the first embodiment.

Accordingly, even if the outer surface temperature and inner surface temperature of the fixing roller 1 are inhomogeneous, it is possible to estimate the maximum allowable thickness of the release layer 93a considerably accurately by using Equation 9. In the case where the fixing belt 93 is partially heated, the maximum temperature T₀ₘₐₓ of the inner surface varies by energy density of the partial heating, so that the relationship between the inner surface average temperature and the inner surface maximum temperature should be studied in advance corresponding to a structure of a heat source at each time.

A case where the heating member is composed of n layers can be generalized and summarized as follows, where αₙ is thermal diffusivity of the release layer, bₙ is thermal permeability of the release layer, and bₙ₋₁ is thermal permeability of the elastic layer:

$${b}_{n - 1} < {b}_{n}$$

$$\sqrt{{α}_{n} t} < {d}_{n} < {r}_{n} [ exp \{ {λ}_{n} [ \frac{2 π}{Q} ( {\hat{T}}_{0} - {\hat{T}}_{n} ) - {\sum }_{j = 1}^{n - 1} \frac{1}{{λ}_{j}} ln \frac{{r}_{j + 1}}{{r}_{j}} ] \} - 1 ]$$

\hat{T}₀ is an inner surface average temperature of the fixing member,

\hat{T}ₙ is an outer surface average temperature of the fixing member,

T₀=\hat{T}₀ (inner surface average temperature)

Tₙ=\hat{T}ₙ (average temperature of outer surface and inner surface)

T₀ₘₐₓ(εT₀)<230° C.

T₀ₘₐₓ is a maximum temperature of the inner circumferential surface, and

230° C. is a heat resistant limit temperature of rubber. . . . Eq. 14

Here, the inductive heating unit 92 eccentrically heats only a part in the rotational direction of the fixing belt 93. Then, an operation condition is set such that the maximum temperature of the inner circumferential surface of the fixing belt 93 is kept below the heat resistant temperature of the n−1^{-th} layer of the fixing belt 93.

This arrangement makes it possible to keep the inner surface temperature of the fixing belt below the heat resistant limit temperature of the silicone rubber material by suppressing the inner surface maximum temperature below 230° C. while fully utilizing the heat transfer characteristic of the release layer in the belt fixing apparatus.

### (Specific Configuration of Second Embodiment)

As shown in FIG. 12, the fixing apparatus 10B is constructed such that a pressing force of the nip portion N is 0.4 MPa, a width in the rotational direction of the nip portion N is 4 mm, a rotational speed of the nip portion N is 400 mm/sec., and a passing time t of the nip portion N is 10 msec.

The surface of the elastic layer 93b is coated by the release layer 93a made of fluoro-rubber of 100 μm in thickness. The high thermal conductive inorganic filler is doped into the release layer 93a to enhance the thermal conductivity of the fluoro-rubber. Table 7 shows thermal physical property values of the respective layers of the fixing belt 93 and the pressure roller 94.

Density of each layer was measured by means of an immersion method by using a density meter. A specific heat was measured by using a differential scanning calorimeter (DSC), and the heat capacity was found from a product of the density and the specific heat. The thermal conductivity was measured by using ai-Phase Mobile 2 (ai-Phase Co., Ltd.).

TABLE 7

| | | | THERMAL | | THERMAL |
|---|---|---|---|---|---|
| | | THICKNESS | CONDUCTIVITY | HEAT CAPACITY | PERMEABILITY |
| | | d [μm] | λ [W/(m · K)] | ρC [J/(m³ · K)] | b [J/(m² · K · s^{0.5})] |
| FIXING | BASE LAYER | 50 | 75 | 4.7 × 10⁵ | 18775 |
| ROLLER | ELASTIC LAYER | 200 | 0.3 | 1.86 × 10⁶ | 747 |
| | RELEASE LAYER | 100 | 0.6 | 2.0 × 10⁶ | 1095 |
| PRESSURE | RELEASE LAYER | 50 | 0.2 | 2.3 × 10⁶ | 678 |
| ROLLER | ELASTIC LAYER | 200 | 0.3 | 1.86 × 10⁶ | 747 |
| | METALLIC BASE | 100 | 90 | 4.0 × 10⁶ | 18974 |
| | LAYER | | | | |

The power Q applied from the inductive heating unit 92 to the fixing belt 93 is 2534[W/m]. When the process of heating the continuous sheet is carried out and the temperature of the fixing belt 93 is put into the stationary state, the outer surface temperature of the fixing belt 93 at the position just before the nip portion N rises to about 179° C.

As shown in FIG. 7A, the lowest fixing temperature is 176° C. when the thickness of the release layer 93a is 100 μm in the case where the nip portion N passing time is 10 msec, so that the toner image is fully fixed by this setting.

Meanwhile, because the part facing to the inductive heating unit 92 of the fixing belt 93 is partially heated, the inner surface temperature is distributed as shown in FIG. 14. The inner surface average temperature of the fixing belt 93 at this time is 203° C. and the inner surface maximum temperature is 209° C., so that they are kept fully lower than the heat resistant temperature of the general silicone rubber of 230° C.

### Third Comparative Example

The outer surface temperature of the fixing belt 93 is substantially constant in a stationary state even if the thickness d of the release layer 93a is changed as shown in FIG. 15. Then, the thickness d of the release layer 93a was thinned to 20 μm in a third comparative example. Then, as shown in FIGS. 6 and 7, heat supplying surplus energy of the fixing belt 93 dropped, a quantity of heat supplied to the toner image became insufficient, and an output image was fixed insufficiently as a result.

### Fourth Comparative Example

The thickness d of the release layer 93a was increased to 560 μm to increase the heat supplying surplus energy of the fixing belt 93 in a fourth embodiment. While the outer surface temperature of the release layer 93a was substantially constant similarly to the second embodiment, a maximum temperature of the base layer 93c and the elastic layer 93b exceeded 230° C. and the durability life of the fixing belt 93 remarkably dropped in the fourth embodiment.

### Third to Fifth Embodiments

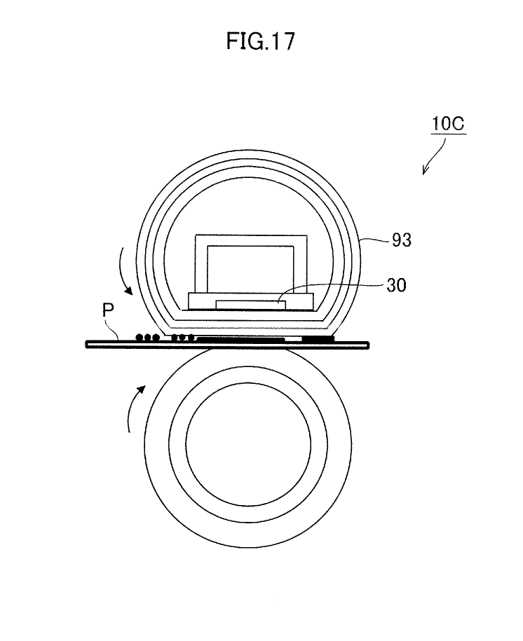

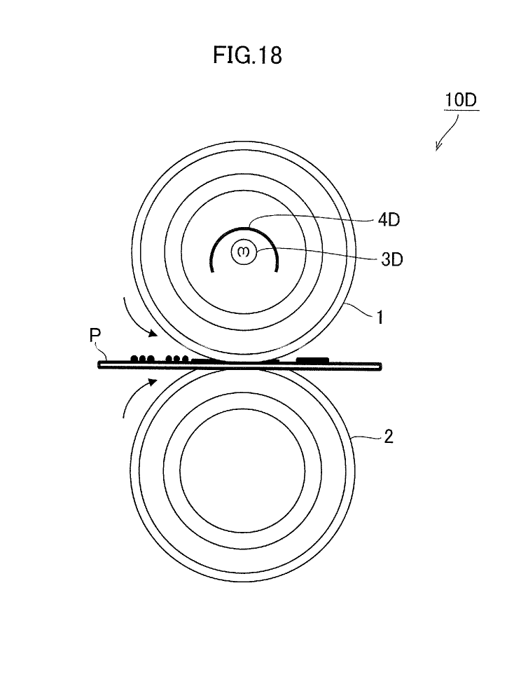

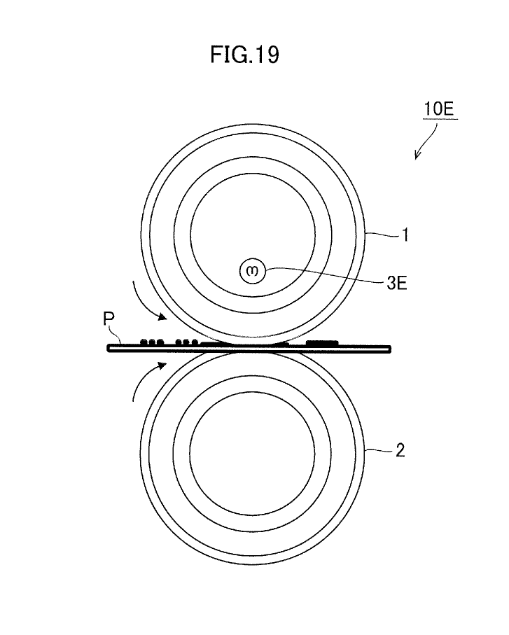

FIG. 17 is a diagram illustrating a configuration of a fixing apparatus of a third embodiment, FIG. 18 is a diagram illustrating a configuration of a fixing apparatus of a fourth embodiment, and FIG. 19 is a diagram illustrating a configuration of a fixing apparatus of a fifth embodiment.

The inductive heating apparatus was used as the heat source of a part of one rotation of the heating member in the second embodiment. However, the heat source for heating the part of one rotation of the heating member is not limited to the inductive heating apparatus.

For instance, as shown in FIG. 17, a ceramic heater 30 is pressed against the inner surface of the fixing belt 93 to locally heat the fixing belt 93 at the nip portion N in a fixing apparatus 10C of a third embodiment. That is, the ceramic heater 30 has a heating range corresponding to a part in the rotational direction of the fixing belt 93 facing the nip portion N and heats the fixing belt 93 wholly in the rotational direction as the fixing belt 93 rotates.

According to a fixing apparatus 10D of a fourth embodiment, a halogen lump 3D and a radiant heat reflecting member 4D are provided within the fixing roller 1 to locally heat the fixing roller 1 at the nip portion N as shown in FIG. 18. That is, the halogen lump 3D has a heating range corresponding to a part in the rotational direction of the fixing roller 1 facing the nip portion N and heats the fixing roller 1 wholly in the rotational direction as the fixing roller 1 rotates.

Further, according to a fixing apparatus 10E of a fifth embodiment, a position where a halogen lump 3E within the fixing roller 1 is shifted from a center position of the fixing roller 1 to locally heat the fixing roller 1 at the nip portion N as shown in FIG. 19. That is, the halogen lump 3E has a heating range corresponding to a part in the rotational direction of the fixing roller 1 facing the nip portion N and heats the fixing roller 1 wholly in the rotational direction as the fixing roller 1 rotates.

The temperature of the heating member can be lowered based on the similar equations with those of the second embodiment in the fixing apparatus of the type of partially heating the inner surface of the heating member.

The present invention may be carried out by other modes in which a part or whole of the configuration of the embodiments is replaced with a substitute configuration thereof as long as the heat storage layer is provided on the surface of the heating member and removal of heat and heating of the heat storage layer are repeated in one rotation of the heating member. Accordingly, the present invention can be carried out in any of a roller-roller fixing apparatus, a belt-belt fixing apparatus, a belt-roller fixing apparatus, and a roller-belt fixing apparatus as long as the image heating apparatus includes the heating member having the elastic layer and the release layer. The image heating apparatus is not limited to the fixing apparatus and may be carried out also in an image surface processing apparatus configured to heat a fixed image or a semi-fixed image.

The image heating apparatus may be carried out not only in the mode mounted in an image forming apparatus, but also as a sole processing component or a component linked to another processing unit. While the embodiments of the invention have been described on the main parts related to the formation and transfer of the toner image, the invention may be carried out in various uses such as a printer, various printing machines, a copier, a facsimile, a multi-function printer, and others by adding necessary units, equipment, and a casing structure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-081031, filed on Apr. 9, 2013 which is hereby incorporated by reference herein in its entirety.

What is claimed is:

1. An image heating apparatus comprising:
a heat source; a heating member heated by the heat source;
a conveying member forming a nip portion conveying a recording medium by being in contact with the heating member;
the heating member including a base layer heated by the heat source, an elastic layer disposed on the base layer, and a release layer disposed on the elastic layer; and
the heating member holding a relationship of the following equation: equation:
\sqrt{α₃t}≦d₃
where,
λ₂[W/(m·K)] is thermal conductivity of the elastic layer,
ρC₂[J/(m³·K)] is heat capacity of the elastic layer,
b₂[J/(m²·K·s^{0.5})](=\sqrt{λ₂ρC₂}) is thermal permeability of the elastic layer,
d₂[m] is a thickness of the elastic layer,
λ₃[W/(m·K)] is thermal conductivity of the release layer,
ρC₃[J/(m³·K)] is heat capacity of the release layer,
b₃[J/(m²·K·s^{0.5})](=\sqrt{λ₃ρC₃}) is thermal permeability of the elastic layer,
d₃[m] is a thickness of the release layer,
the thermal permeability b₃ of the release layer being greater than the thermal permeability b₂ of the elastic layer,
α₃[m²/s] is thermal diffusivity of the release layer, and
t [s] is the recording medium stay time at the nip portion.

2. The image heating apparatus according to claim 1, wherein the heating member is cylindrical; and
the heating member holds a relationship of the following equation:
$${d}_{3} = {r}_{3} [ exp \{ {λ}_{3} [ \frac{2 π}{Q} ( {\hat{T}}_{0} - {\hat{T}}_{3} ) - \frac{1}{{λ}_{1}} ln \frac{{r}_{2}}{{r}_{1}} - \frac{1}{{λ}_{2}} ln \frac{{r}_{3}}{{r}_{3}} ] \} - 1 ]$$
where, r₁[m] is an inner diameter of the base layer, r₂ [m] is an inner diameter of the elastic layer, r₃[m] is an inner diameter of the release layer,
l [m] is a length in a rotational axis direction of the heating member,
Q [W/m] is a power inputted to the heat source per unit length in the rotational axis direction of the heating member,
\hat{T}₃[° C.] is an outer surface average temperature of the heating member,
\hat{T}₀[° C.] is an inner surface average temperature of the heating member,
λ₁[W/(m·k)] is thermal conductivity of the base layer,
λ₂[W/(m·k)] is thermal conductivity of the elastic layer, and
λ₃[W/(m·k)] is thermal conductivity of the release layer.

3. An image heating apparatus comprising:
a heat source;
a heating member heated by the heat source;
a conveying member forming a nip portion conveying a recording medium by being in contact with the heating member;
the heating member having a multi-layered structure of n layers in total assigned by layer numbers sequentially from one on the heat source side to the surface in contact with the recording medium; and
the heating member holding a relationship of the following equation:
\sqrt{αₙt}≦dₙ
where, λⱼ[W/(m·K)] is thermal conductivity of a j^{-th} (j=1 to n) layer,
ρCⱼ[J/(m³·K)] is heat capacity of the j^{-th} (j=1 to n) layer, bⱼ[J/(m²·K·s^{0.5})](=\sqrt{λⱼρCⱼ}) is thermal permeability of the j^{-th} (j=1 to n) layer,
dⱼ[m] is a thickness of the j^{-th} (j=1 to n) layer, the thermal permeability bₙ of the n^{-th} layer being greater than the thermal permeability bₙ₋₁ of the fixing roller 1-n^{-th} layer,
αₙ[m²/s] is thermal diffusivity of the j^{-th} (j=1 to n) layer,
dₙ[m] is a thickness of the n^{-th} layer, and
t[s] is the recording medium stay time at the nip portion.

4. The image heating apparatus according to claim 3, where an inner diameter of the j^{-th} layer of the heating member formed into the cylindrical shape is denoted as rⱼ[m],
the image heating apparatus holding a relationship of the following equation:
$${d}_{n} = {r}_{n} [ exp \{ {λ}_{n} [ \frac{2 π}{Q} ( {\hat{T}}_{0} - {\hat{T}}_{n} ) - {\sum }_{j = 1}^{n - 1} \frac{1}{{λ}_{j}} ln \frac{{r}_{j + 1}}{{r}_{j}} ] \} - 1 ]$$
where, l [m] is a length in a rotational axis direction of the heating member,
Q [W/m] is a power inputted to the heat source per unit length in the rotational axis direction of the heating member,
\hat{T}ₙ[° C.] is the outer surface average temperature of the heating member,
\hat{T}₀[° C.] is the inner surface average temperature of the heating member,
rⱼ[m] is an inner diameter of the J^{-th} layer, and
λⱼ[W/(m·k)] is thermal conductivity of the j^{-th} layer.

5. The image heating apparatus according to claim 2, wherein the heat source heats the heating member homogeneously wholly in the rotational direction, and
wherein the average temperature of the inner circumferential surface of the heating member is less than a heat resistant temperature of the elastic layer of the heating member in an operation state defined by Equation described in claim 2.

6. The image heating apparatus according to claim 4, wherein the heat source heats the heating member homogeneously wholly in the rotational direction, and
wherein the average temperature of the inner circumferential surface of the heating member is less than a heat resistant temperature of a second layer from an inside of the heating member in an operation state defined by Equation described in claim 4.

7. The image heating apparatus according to claim 2, wherein the heat source has a heating range corresponding to a part in the rotational direction of the heating member and heats the heating member wholly in the rotational direction as the heating member rotates, and
wherein a maximum temperature of the inner circumferential surface of the heating member is less than a heat resistant temperature of the elastic layer of the heating member in the operation state defined by Equation described in claim 2.

8. The image heating apparatus according to claim 4, wherein the heat source heats has a heating range corresponding to a part in the rotational direction of the heating member and heats the heating member wholly in the rotational direction as the heating member rotates, and
wherein a maximum temperature of the inner circumferential surface of the heating member is less than a heat resistant temperature of a second layer from an inside of the heating member in the operation state defined by Equation described in claim 4.

9. The image heating apparatus according to claim 1, wherein elastic modulus of the elastic layer on which the release layer is disposed is smaller than elastic modulus of the release layer, and
wherein a contact angle of the surface of the release layer to melted toner is larger than a contact angle of the surface of the elastic layer to the melted toner in a same temperature.

10. The image heating apparatus according to claim 2, wherein elastic modulus of the elastic layer on which the release layer is disposed is smaller than elastic modulus of the release layer, and
wherein a contact angle of the surface of the release layer to melted toner is larger than a contact angle of the surface of the elastic layer to the melted toner in a same temperature.

11. The image heating apparatus according to claim 3, wherein elastic modulus of the n−1^{-th} layer is smaller than elastic modulus of the n^{-th} layer, and
wherein a contact angle of the surface of the n^{-th} layer to melted toner is larger than a contact angle of the surface of the n−1^{-th} layer to the melted toner in a same temperature.

12. The image heating apparatus according to claim 4, wherein elastic modulus of the n−1^{-th} layer is smaller than elastic modulus of the n^{-th} layer, and
wherein a contact angle of the surface of the n^{-th} layer to melted toner is larger than a contact angle of the surface of the n−1^{-th} layer to the melted toner in a same temperature.
